(19) United States
(12) Patent Application Publication
(10) Pub. No.: US 2017/0305338 A1
(43) Pub. Date: Oct. 26, 2017

(54) VEHICLE WARNING SYSTEM AND METHOD

(71) Applicant: HON HAI PRECISION INDUSTRY CO., LTD., New Taipei (TW)

(72) Inventors: HUNG-CHUN LU, New Taipei (TW); TZU-CHENG YANG, New Taipei (TW); YU-CHING CHIEN, New Taipei (TW); YU-CHIEN WU, New Taipei (TW)

(21) Appl. No.: 15/181,624

(22) Filed: Jun. 14, 2016

(30) Foreign Application Priority Data
Apr. 26, 2016 (TW) 105112932

(51) Int. Cl. B60Q 1/52; H04W 4/00; G10L 15/22

(52) U.S. Cl. CPC B60Q 1/52; G10L 15/22; H04W 4/008

(57) ABSTRACT

A warning system for a vehicle includes a mobile warning tripod and a portable electronic device communicating with the tripod. The tripod includes a driving unit, a movement unit, and a warning unit. The electronic device has an application with a user interface. The user interface includes icons to control a movement control unit in the electronic device. The movement control unit sends control signals to the driving unit of the tripod in response to user operations on one or more of the icons. The driving unit moves the tripod to move as required. A vehicle warning method is also disclosed.

### CROSS-REFERENCE TO RELATED APPLICATIONS

This application claims priority to Taiwan Patent Application No. 105112932, filed on Apr. 26, 2016, the contents of which are incorporated by reference herein.

### FIELD

The subject matter herein generally relates to road safety, and especially relates to a vehicle warning system and method.

### BACKGROUND

Accidents often occur on highways. When an accident occurs, the driver should position a warning tripod one hundred meters behind a stationary vehicle to alert approaching vehicles.

### BRIEF DESCRIPTION OF THE DRAWINGS

Implementations of the present technology will now be described, by way of example only, with reference to the attached figures.

FIG. 1 is an isometric view of a warning tripod of the vehicle warning system in FIG. 1 at a first state.

FIG. 2 is an isometric view of the warning tripod in FIG. 2 at a second state.

FIG. 3 is a block diagram of a vehicle warning system according to an embodiment.

FIG. 4 is a flowchart of a vehicle warning method according to an embodiment.

FIG. 5 is another flowchart of the vehicle warning method in FIG. 4.

FIG. 6 is another flowchart of the vehicle warning method in FIG. 5.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

A definition that applies throughout this disclosure will now be presented.

The term “comprising” means “including, but not necessarily limited to”; it specifically indicates open-ended inclusion or membership in a so-described combination, group, series, and the like.

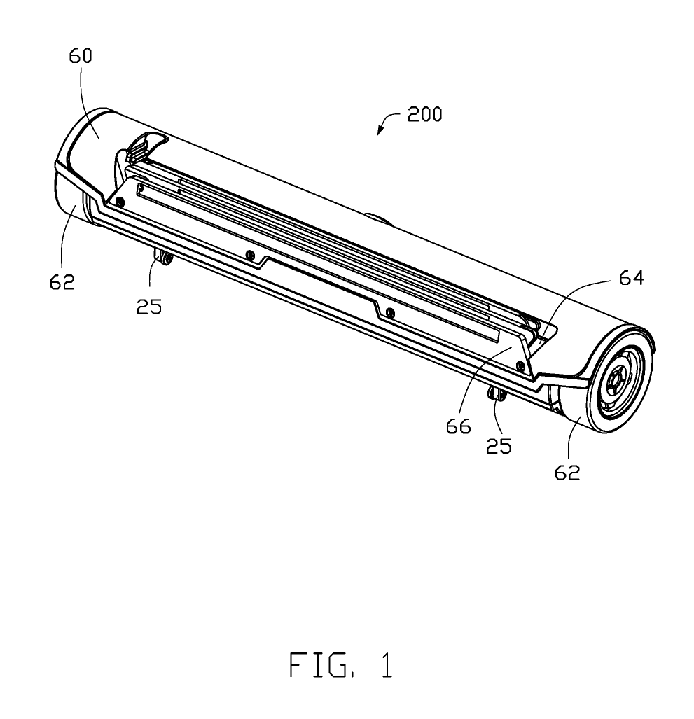

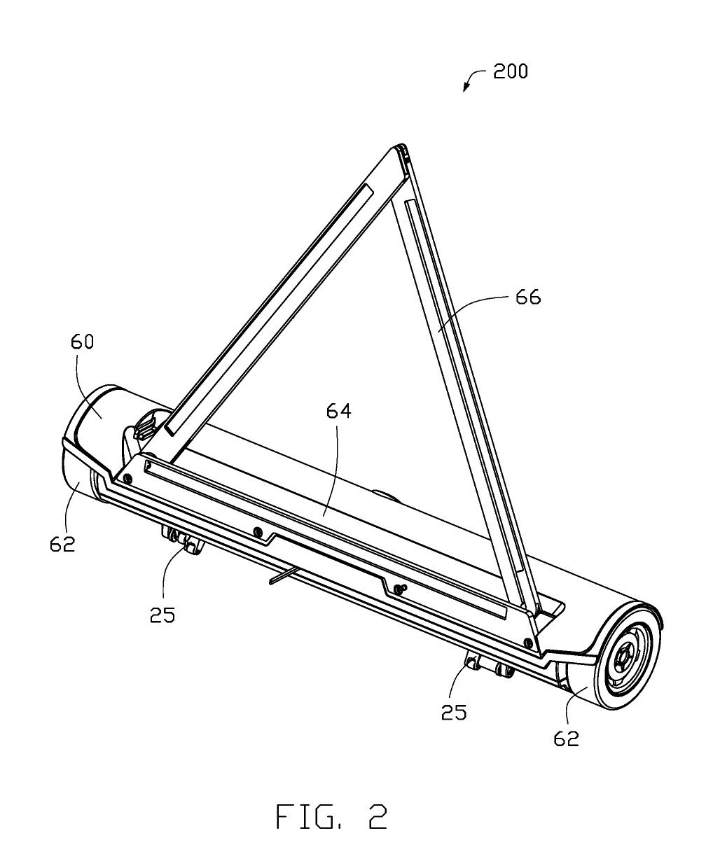

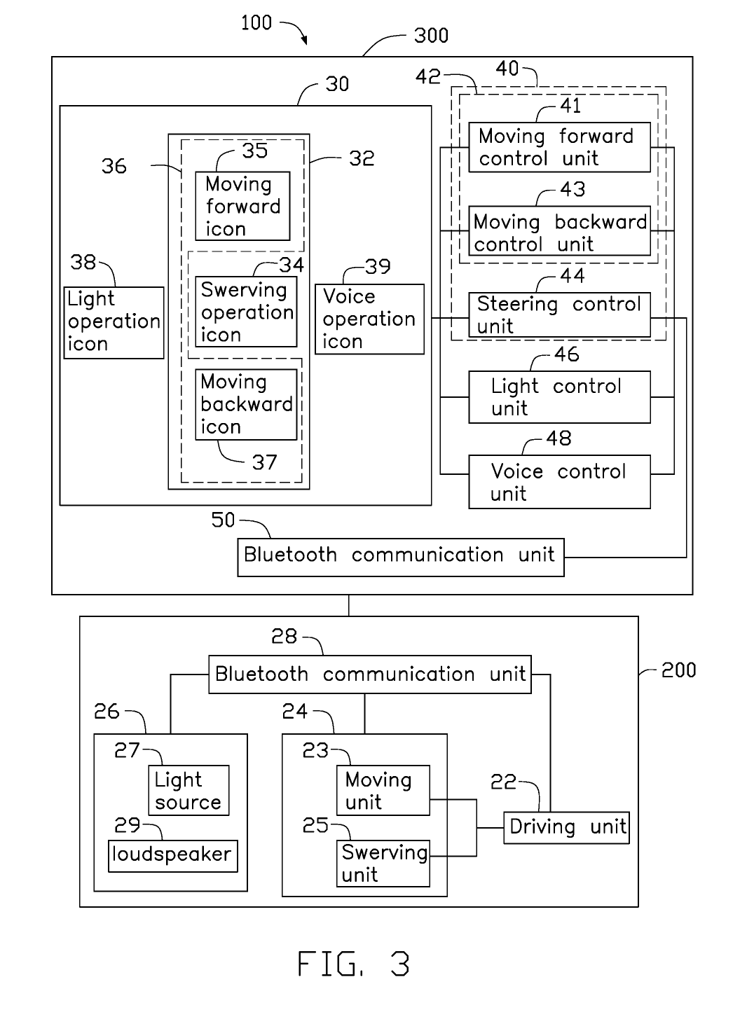

The instant disclosure provides a vehicle warning system 100. The vehicle warning system 100 includes a warning tripod 200 and a portable electronic device 300 communicating with the warning tripod 200 as shown in FIGS. 1 and 2. In FIG. 3, the warning tripod 200 includes a driving unit 22, a movement unit 24, and a warning unit 26. The electronic device 300 has an application. The application provides a user interface 30. The user interface 30 includes at least one move operation icon 32. The electronic device 300 includes a move control unit 40. The move control unit 40 is configured to send movement control signal to the driving unit 22 in response to an operation to the move operation icon 32. According to the movement control signal, the driving unit 22 drives the movement unit 24 to move in certain ways. The warning unit 26 can follow the driving unit 22 to alert other vehicles audibly and visually. The warning tripod 200 and the electronic device 300 include two BLUETOOTH communication units 28, 50. The electronic device 300 transmits the movement control signal to the warning tripod 200 through BLUETOOTH. The electronic device 300 may be a mobile phone. The driving unit 22 may be a stepper motor.

The move operation icon 32 includes moving operation icons 36 and swerving operation icons 34. The move control unit 40 includes a moving control unit 42 and a steering control unit 44. The moving control unit 42 sends a moving control signal in response to an operation to the moving operation icon 36. The steering control unit 44 sends a swerving control signal in response to an operation to the swerving operation icon 34. The movement unit 24 includes a moving unit 23 and a swerving unit 25. The driving unit 22 connects to the moving unit 23 and the swerving unit 25. The driving unit 22 drives the swerving unit 25 to swerve in response to the swerving control signal and drives the moving unit 23 to move in the direction of swerve in response to the moving control signal.

The moving operation icon 36 includes a moving forward icon 35 and a moving backward icon 37. The moving control unit 42 includes moving forward control unit 41 and moving backward control unit 43. The moving forward control unit 41 sends a moving forward control signal in response to an operation to the moving forward icon 35. The moving backward control unit 43 sends a moving backward control signal in response to an operation to the moving backward icon 37. The driving unit 22 drives the moving unit 23 to move forward in response to the moving forward control signal and drives the moving unit 23 to move backward in response to the moving backward control signal.

The warning unit 26 includes at least one light source 27 and at least one loudspeaker 29. The electronic device 300 further includes a light control unit 46 and a voice control unit 48. The user interface 30 further includes a light operation icon 38 and a voice operation icon 39. The light control unit 46 sends a light control signal in response to an operation to the light operation icon 38 to illuminate or not illuminate the light source 27. The voice control unit 48 sends a voice control signal in response to an operation to the voice operation icon 39 to control the loudspeaker 29 to emit an audible alert.

FIGS. 1 and 2 illustrate the warning tripod 200, which includes a cylindrical main body 60. The moving unit 23, the swerving unit 25, and the loudspeaker 29 are all mounted to the main body 60. The moving unit 23 includes two wheels 62 positioned at two ends of the main body 60. The swerving unit 25 is mounted to the bottom of the main body 60 and is positioned between the two wheels 62. The main body 60 defines a receiving groove 64. The warning unit 26 includes a foldable tripod 66. The light source 27 (not shown in FIG. 2) is positioned on the foldable tripod 66. The light source 27 can be any type of light emitting unit such as a light emitting diode and is not limited to the examples provided herein. The foldable tripod 66 can be unfolded to alert other vehicles and can be folded or refolded to be received in the receiving groove 64.

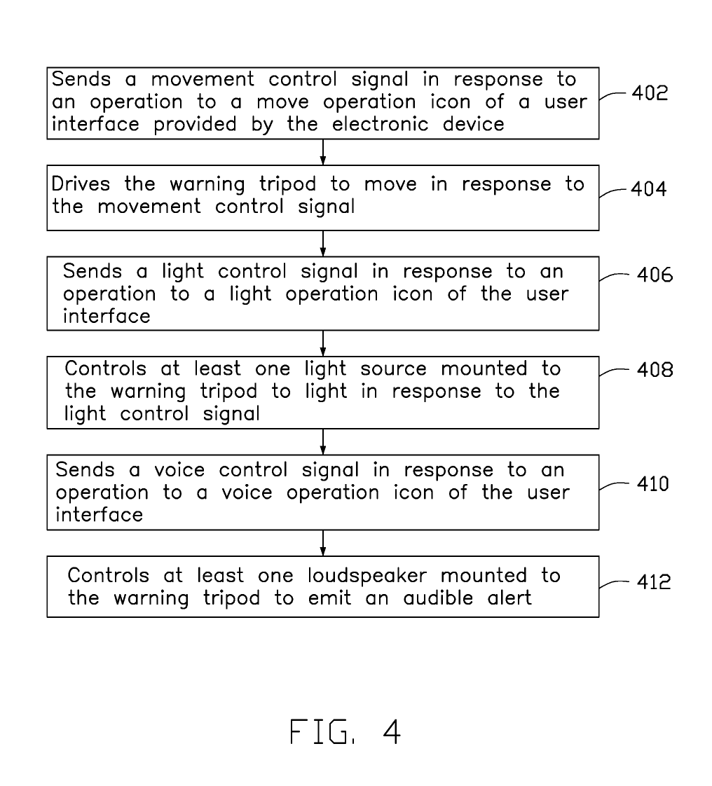

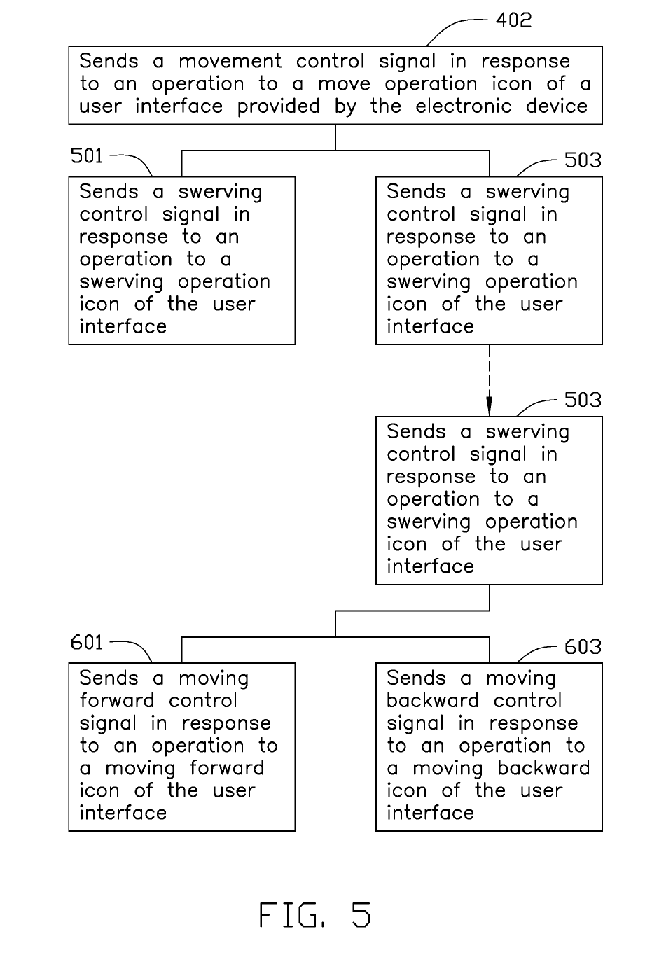

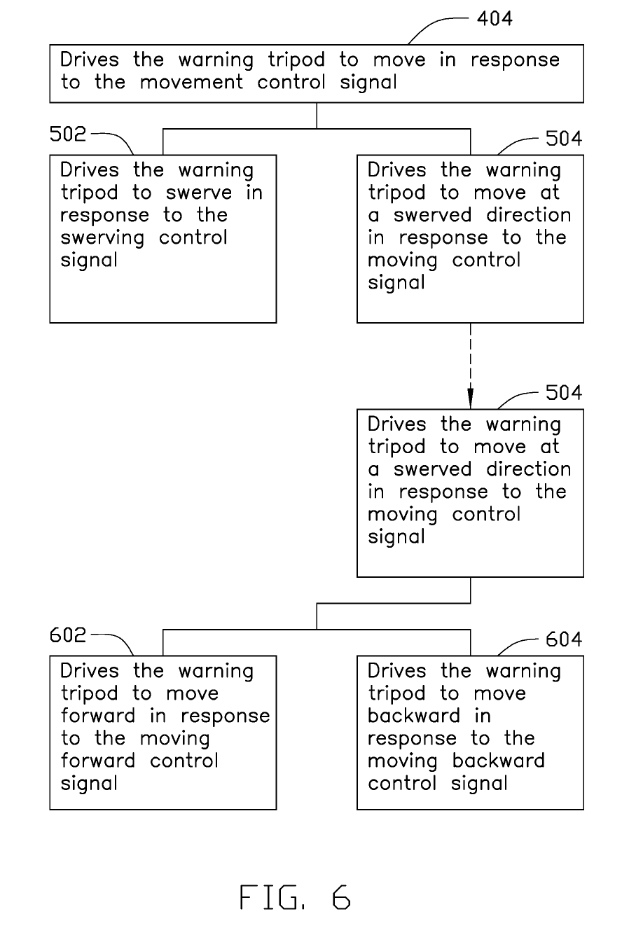

FIGS. 4 to 6 illustrate a vehicle warning method according to an embodiment. The method is employed to control a warning tripod 200 communicating with the portable electronic device 300. The order of blocks in FIGS. 4 to 6 is illustrative only and the order of the blocks can change. Additional blocks can be added or fewer blocks may be utilized without departing from this disclosure. The exemplary method begins at block 402.

At block 402, the move control unit 40 sends a movement control signal in response to an operation to a move operation icon 32 of a user interface 30 provided by the electronic device 300.

At block 404, the driving unit 22 drives the warning tripod 200 to move in response to the movement control signal.

At block 406, the light control unit 46 sends a light control signal in response to an operation to a light operation icon 38 of the user interface 30.

At block 408, the warning tripod 200 controls at least one light source 27 mounted to the warning tripod 200 to illuminate in response to the light control signal.

At block 410, the voice control unit 48 sends a voice control signal in response to an operation to a voice operation icon 39 of the user interface 30.

At block 412, the warning tripod 200 controls at least one loudspeaker 29 mounted to the warning tripod 200 to emit an audible alert.

The block 402 includes the following blocks.

At block 501, the steering control unit 44 sends a swerving control signal in response to an operation to a swerving operation icon 34 of the user interface 30.

At block 503, the moving control unit 42 sends a moving control signal in response to an operation to a moving operation icon 36 of the user interface 30.

The block 503 includes the following blocks.

At block 601, the moving forward control unit 41 sends a moving forward control signal in response to an operation to a moving forward icon 35 of the user interface 30.

At block 603, the moving backward control unit 43 sends a moving backward control signal in response to an operation to a moving backward icon 37 of the user interface 30.

The block 404 includes the following blocks.

At block 502, the driving unit 22 drives the warning tripod 200 to swerve in response to the swerving control signal.

At block 504, the driving unit 22 drives the warning tripod 200 to move in the direction of swerve in response to the moving control signal.

The block 504 includes the following blocks.

At block 602, the driving unit 22 drives the warning tripod 200 to move forward in response to the moving forward control signal.

At block 604, the driving unit 22 drives the warning tripod 200 to move backward in response to the moving backward control signal.

The embodiments shown and described above are only examples. Even though numerous dataistics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. A vehicle warning system comprising:
a portable electronic device providing a user interface and comprising a move control unit, the user interface comprising at least one move operation icon, the move control unit configured to send a movement control signal in response to an operation to the move operation icon; and
a warning tripod comprising:
a movement unit;
a driving unit configured to drive the movement unit to move according to the movement control signal; and
a warning unit, providing an alert signal to alert vehicles when the driving unit being in motion.

2. The vehicle warning system as claimed in claim 1, wherein the move operation icon comprises at least one moving operation icons and at least one swerving operation icons, the move control unit comprises a moving control unit and a steering operation unit, the moving control unit sends a moving control signal in response to an operation to the moving operation icon, the steering control unit sends a swerving control signal in response to an operation to the swerving operation icon.

3. The vehicle warning system as claimed in claim 2, wherein the movement unit comprises a moving unit and a swerving unit, the driving unit connects to the moving unit and the swerving unit, the driving unit drives the swerving unit to swerve in response to the swerving control signal and drives the moving unit to move in the direction of swerve in response to the moving control signal.

4. The vehicle warning system as claimed in claim 3, wherein the moving operation icon comprises a moving forward icon and a moving backward icon, the moving control unit comprises a moving forward control unit and a moving backward control unit, the moving forward control unit sends a moving forward control signal in response to an operation to the moving forward icon, the moving backward control unit sends a moving backward control signal in response to an operation to the moving backward icon.

5. The vehicle warning system as claimed in claim 4, wherein the driving unit drives the moving unit to move forward in response to the moving forward control signal and drives the moving unit to move backward in response to the moving backward control signal.

6. The vehicle warning system as claimed in claim 1, wherein the warning unit comprises at least one light source, the portable electronic device further comprises a light control unit to control the illumination of the light source.

7. The vehicle warning system as claimed in claim 6, wherein the user interface further comprises a light operation icon, the light control unit sends a light control signal in response to an operation to the light operation icon to control the light source.

8. The vehicle warning system as claimed in claim 1, wherein the warning unit comprises at least one loudspeaker, the portable electronic device further comprises a voice control unit to control the loudspeaker to emit an audible alert.

9. The vehicle warning system as claimed in claim 8, wherein the user interface further comprises a voice operation icon, the voice control unit sends a voice control signal in response to an operation to the voice operation icon to control the loudspeaker.

10. The vehicle warning system as claimed in claim 1, wherein the portable electronic device is a mobile phone.

11. A vehicle warning method to control a warning tripod in communication with a portable electronic device, the method comprising:
sending a movement control signal in response to an operation to a move operation icon of a user interface provided by the electronic device; and driving the warning tripod to move in response to the movement control signal.

12. The method as claimed in claim 11, further comprising:
sending a voice control signal in response to an operation to a voice operation icon of the user interface; and
controlling at least one loudspeaker mounted to the warning tripod to emit an audible alert.

13. The method as claimed in claim 11, wherein the step of sending a movement control signal in response to an operation to a movement operation icon of a user interface provided by the electronic device comprising:
sending a swerving control signal in response to an operation to a swerving operation icon of the user interface; and
sending a moving control signal in response to an operation to a moving operation icon of the user interface.

14. The method as claimed in claim 13, wherein the step of sending a moving control signal in response to an operation to a moving operation icon of the user interface comprising:
sending a moving forward control signal in response to an operation to a moving forward icon of the user interface; and
sending a moving backward control signal in response to an operation to a moving backward icon of the user interface.

15. The method as claimed in claim 14, wherein the step of driving the warning tripod to move in response to the movement control signal comprising:
driving the warning tripod to swerve in response to the swerving control signal; and
driving the warning tripod to move in the direction of swerve in response to the moving control signal.

16. The method as claimed in claim 15, wherein the step of driving the warning tripod to move in the direction of swerve in response to the moving control signal comprising:
driving the warning tripod to move forward in response to the moving forward control signal; and
driving the warning tripod to move backward in response to the moving backward control signal.

17. The method as claimed in claim 11, further comprising:
sending a light control signal in response to an operation to a light operation icon of the user interface; and
controlling at least one light source mounted to the warning tripod to control illumination in response to the light control signal.
